(19) United States
(12) Patent Application Publication
(10) Pub. No.: US 2008/0054602 A1
(43) Pub. Date: Mar. 6, 2008

(54) PASSENGER SIDE TWIN AIRBAG MODULE ASSEMBLY

(75) Inventor: Jae-Sung Yang, Bloomfield, MI (US)

Correspondence Address: KEY SAFETY SYSTEMS, INC.;PATENT DEPARTMENT, 5300 ALLEN K BREED HIGHWAY, LAKELAND, FL, 33811-1130, US

(73) Assignee: KEY SAFETY SYSTEMS, INC., Sterling Heights, MI (US)

(21) Appl. No.: 11/468,124

(22) Filed: Aug. 29, 2006

(51) Int. Cl. B60R 21/233; B60R 21/26

(52) U.S. Cl. 280/729; 280/736

(57) ABSTRACT

A passenger side airbag module assembly for restraining movement of an adult or a child is disclosed. The module has an airbag module housing holding an upper airbag, and a lower airbag positioned in front of the upper airbag. The module may have either a single inflator or two inflators. Upon deployment the lower airbag has an upper surface that extends outwardly from the housing in a substantially horizontal or lower than horizontal direction and the upper airbag extends with a lower surface adjacent to the upper surface of the lower airbag; the upper airbag being deployed adjacent to the windshield of the motor vehicle and above the lower airbag.

### FIELD OF THE INVENTION

This invention relates to passenger front side airbags for a motor vehicle.

### BACKGROUND OF THE INVENTION

Inflatable restraints or airbags are deployed in motor vehicle crashes to reduce injuries of the vehicle occupants. The airbags are stored in airbag modules installed in various parts of the motor vehicle, such as within the steering wheel or behind the instrument panel. In addition to the airbag module housing an airbag, it also houses an inflator that provides gas for inflating the airbag. When the motor vehicle undergoes rapid deceleration, as occurs during a crash, the airbag rapidly inflates due to the introduction of an inflation gas into the airbag interior.

Traditionally, airbags were designed to protect the 50th percentile man who was not out of position. An out of position vehicle occupant is one that is not sitting properly in his/her seat. For example, when the vehicle occupant is leaning toward the front of the motor vehicle, or the vehicle occupant has a limb near or touching the instrument panel, etc. he or she is considered to be out of position. Since airbags are aggressively filled, an out of position vehicle occupant, an unrestrained vehicle occupant, or a child may be injured by contacting the airbag while it is being inflated. There has been much effort in developing a smart airbag system that can detect the size and position of a vehicle occupant. These smart airbag systems often require sophisticated airbag designs that have multiple compartments and tethers.

U.S. Pat. No. 5,310,214 A discloses an airbag that has an upper chamber for restraining an adult and a lower chamber for holding gas to restrain a child. The system provides two separate gas sources that are simultaneously activated to inflate the upper and lower chambers. The first gas source fills the upper chamber and provides more gas than the second gas source that fills the lower chamber with the result being a high gas pressure in the upper chamber and a lower gas pressure in the lower chamber. The lower chamber is for restraining a child, and the upper chamber is for restraining an adult.

U.S. Pat. No. 6,709,009 B1 discloses an airbag module having two inflators with two airbags. The first airbag has substantially an “L” cross-section in its deployed state. The second airbag is attached to the first airbag by stitching. Three different deployment scenarios are contemplated by the present invention. The first deployment scenario is the deployment of only the first airbag. The second deployment scenario is the deployment of only the second airbag. The last deployment scenario is the deployment of the first and second airbags. The “L” shaped airbag has a larger volume and when deployed provides a large contact area for an adult vehicle occupant such that only the “L” shaped airbag contacts the vehicle occupants torso when both airbags are deployed.

US 2005/0029781 A1 discloses a two airbag cushion inflated by either a dual stage inflator or by two separate inflators is described wherein the first cushion is deployed vertically along the windshield at less than two pounds per square inch and can be used to gently push any out of position vehicle occupant toward the passenger seat and thereafter the second airbag cushion can be inflated and is positioned behind the first airbag cushion and thus between the windshield and the first airbag.

In these prior art two cushion airbag systems there is no provision to avoid the airbag striking the region of the head of a vehicle occupant with an upward thrust force such that the neck of the vehicle occupant can be injured due to the airbag deploying and being struck under the vehicle occupant's chin.

It is therefore desirable to provide a front passenger side airbag system that is low in cost and can reliably satisfy the requirements for a one-year-old infant, three year old and six year old children and simultaneously meet the injury requirements for 5^{th} and 50^{th} percentile adults.

### SUMMARY OF THE INVENTION

A passenger side airbag module assembly for restraining movement of an adult or a child is disclosed. The module has an airbag module housing holding an upper airbag, and a lower airbag positioned in front of the upper airbag. The module may have either a single inflator or two inflators. Upon deployment the lower airbag has an upper surface that extends outwardly from the housing in a substantially horizontal or lower than horizontal direction and the upper airbag extends with a lower surface adjacent to the upper surface of the lower airbag; the upper airbag being deployed adjacent to the windshield of the motor vehicle and above the lower airbag.

### BRIEF DESCRIPTION OF THE DRAWINGS

FIG. 1 is a plan view of the passenger compartment of a motor vehicle showing three simulated vehicle occupants of various sizes.

FIG. 2A is a plan view similar to FIG. 1 showing a 50^{th} percentile male.

FIG. 2B is the plan view of FIG. 2A showing the initial contact of the airbags with the 50^{th} percentile male.

FIG. 3A is a plan view similar to FIG. 1 showing the 5^{th} percentile female.

FIG. 3B is the plan view of FIG. 3A showing the initial contact of the airbags with the 5^{th} percentile female.

FIG. 4A is a plan view similar to FIG. 1 showing a three to six year old child.

FIG. 4B is the plan view of FIG. 4A showing the initial contact of the airbags with the three to six year old child.

FIG. 5A is a larger toddler in a forward seated child motor vehicle rear seat with the airbag of the present invention deployed.

FIG. 5B is a plan view of a passenger compartment of a motor vehicle with a small toddler in a rearward facing child seat and the airbags of the present invention deployed.

FIG. 5C is an infant in a rearward facing infant seat attached to the front passenger seat with the airbags of the present invention deployed.

FIG. 6 is a perspective view of a base plate with two inflators.

FIG. 7 is a side cross sectional view of the base plate with an inflator.

FIG. 8 is a perspective view of the two top plates.

FIG. 9 is a perspective view of an airbag module assembly.

FIG. 10 is a perspective view of a preferred embodiment module assembly having a single dual level or dual stage inflator.

FIG. 11 is a cross sectional view of the preferred module assembly of FIG. 10.

### DETAILED DESCRIPTION OF THE INVENTION

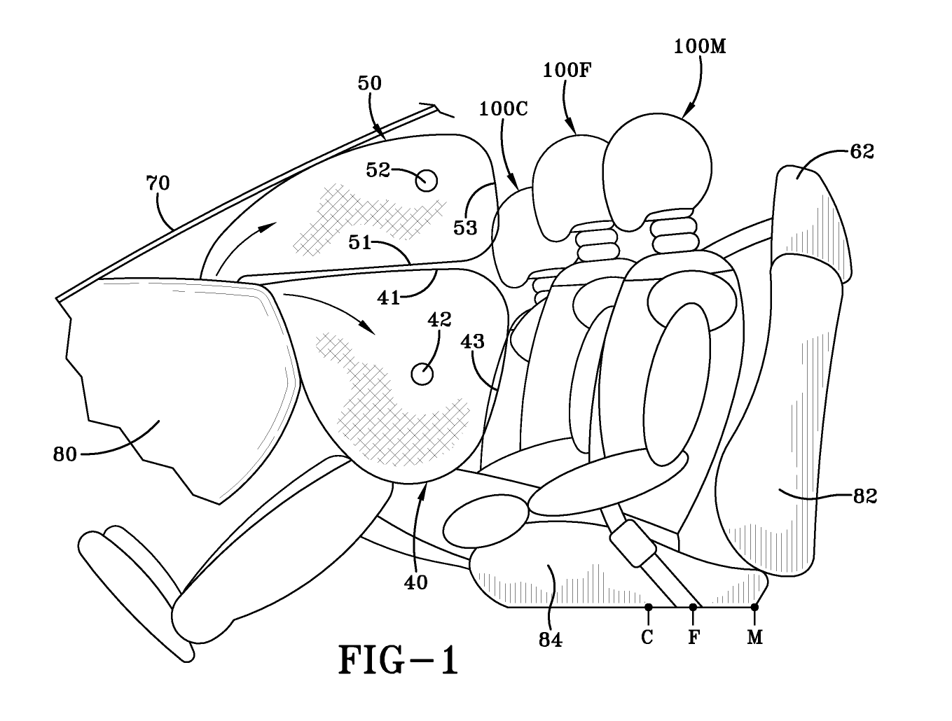

With reference to FIGS. 1-5 the airbags 40, 50 of the airbag module assembly 30 of the present invention are shown in various stages of deployment with vehicle occupants of different sizes. FIG. 1 is a plan view of the passenger compartment of a motor vehicle showing three simulated vehicle occupants, a three to six year old child, a 5^{th} percentile female and a 50^{th} percentile male all seated in a typical relationship based on their respective size. In FIG. 1 the three vehicle occupants are shown superimposed so that the relative position and size of the vehicle occupants can be easily visualized. In FIG. 1 all of the airbags of the present invention are shown being initially deployed. As shown a child 100C in the three to six year old range is shown in the most forward position. A female 100F of the 5percentile size is shown in the middle position, and the male 100M of the 50^{th} percentile is shown in the furthest back position on the seat 82. For each seating position shown there is an indication of the location marked by a C, F or M for the various vehicle occupants. As shown the seat 82 is in the position M or furthest back and is shown near the lowest part of the seat portion 84 of the seat 82 at the indication of location mark M. The airbags 40, 50 are shown in the initial deployment stages. The lower airbag 40 deploys substantially horizontally towards the torsos of the vehicle occupants whereas the upper airbag 50 is positioned above the lower airbag 40 and between the lower airbag and the windshield 70. Both of the airbags 40, 50 are shown coming from the instrument panel 80.

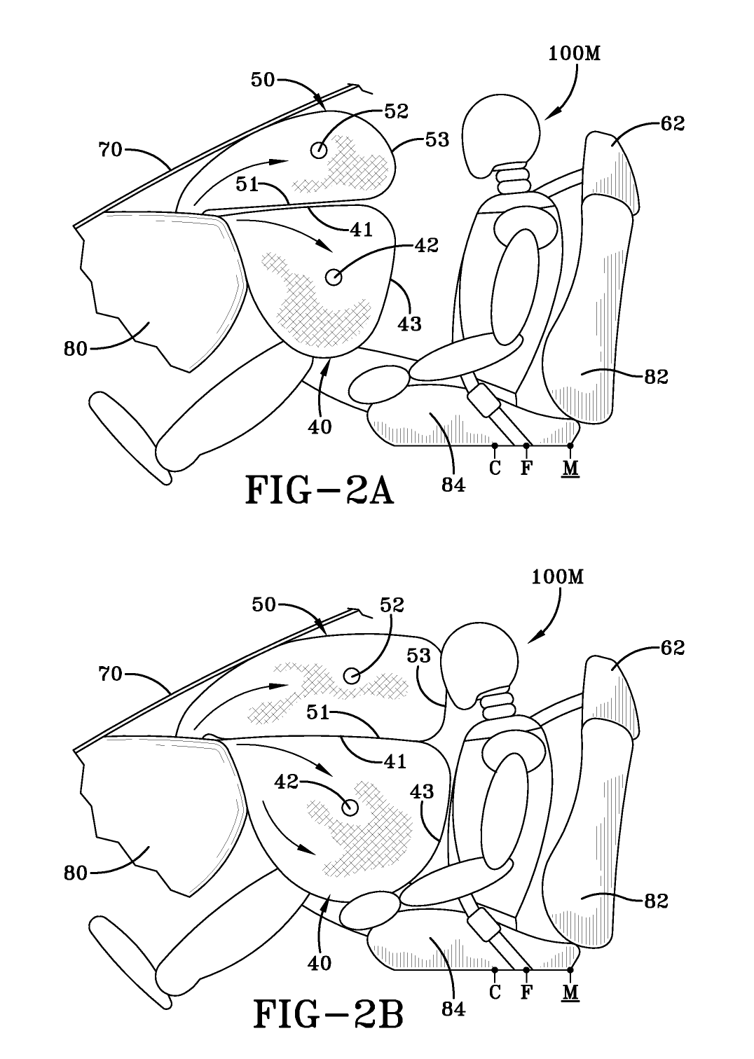

With reference to FIGS. 2A and 2B the airbags 40, 50 are shown initially deployed in FIG. 2A as the airbags are projecting outwardly. It can be initially observed that the 50^{th} percentile male 100M seated in the location M is further back than the airbag and therefore as the airbags deploy the lower airbag strikes the male around the torso approximately in the chest area driving him further back into the seat whereas the upper airbag is independently striking the head region. It is believed that this method of providing two independently operable airbags provides a system that is less traumatic to the head and neck region as the airbag is being deployed. This is true in that the airbag's primary force can be provided in the lower airbag which would drive the vehicle occupant back into the fully seated position while the upper airbag maintains the head contact and will strike in such a fashion that it does not provide an upward thrust as is commonly found in conventional front passenger airbags wherein the airbag deployment provides an aggressive upward force causing the neck to take an exaggerated movement that can in some cases cause neck injuries. This clearly is avoided in the present invention in that the airbags acting independently will strike the vehicle occupant in such a fashion that the contact avoids the driving of the head in an upward thrusting motion, and instead pushes mostly horizontally backwards towards the seat and the seat headrest. In each of the views it is shown that the vehicle occupant is restrained by the seatbelt system 62.

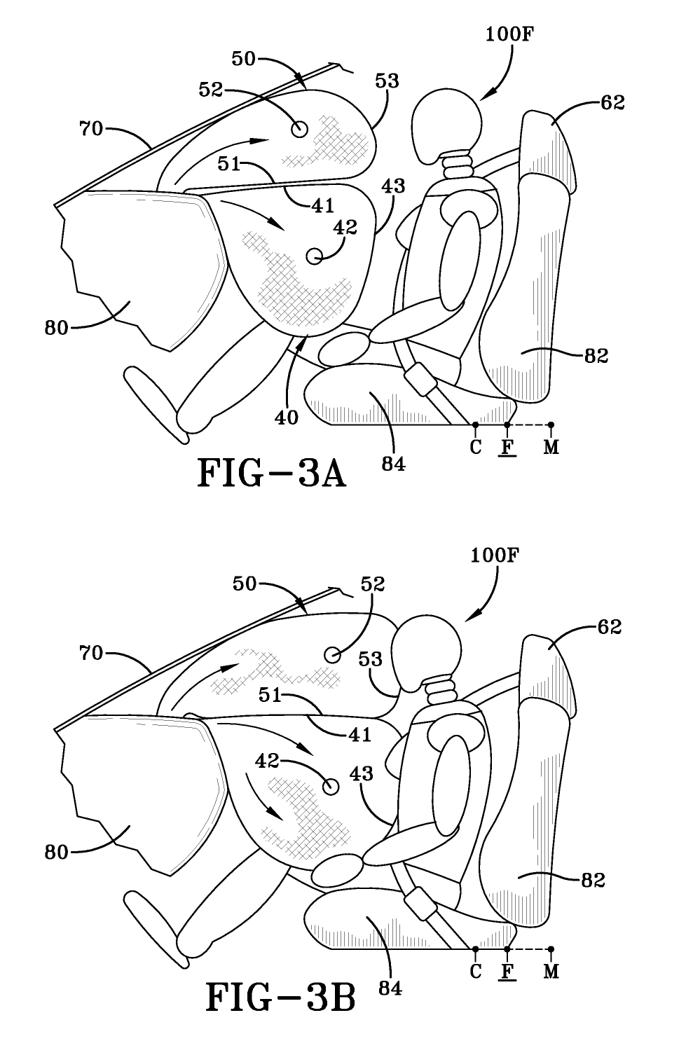

With reference to FIGS. 3A and 3B a female 100F of the 5^{th} percentile is shown where the seat 82 is moved to the position F. The seat 82 as shown with the female 100F restrained by the seatbelt system 62 in such a fashion that the lower airbag 40 and upper airbag 50 similarly will strike the female vehicle occupant 100F in the torso area with the lower airbag 40 while the upper airbag 50 strikes the head of the female vehicle occupant 100F.

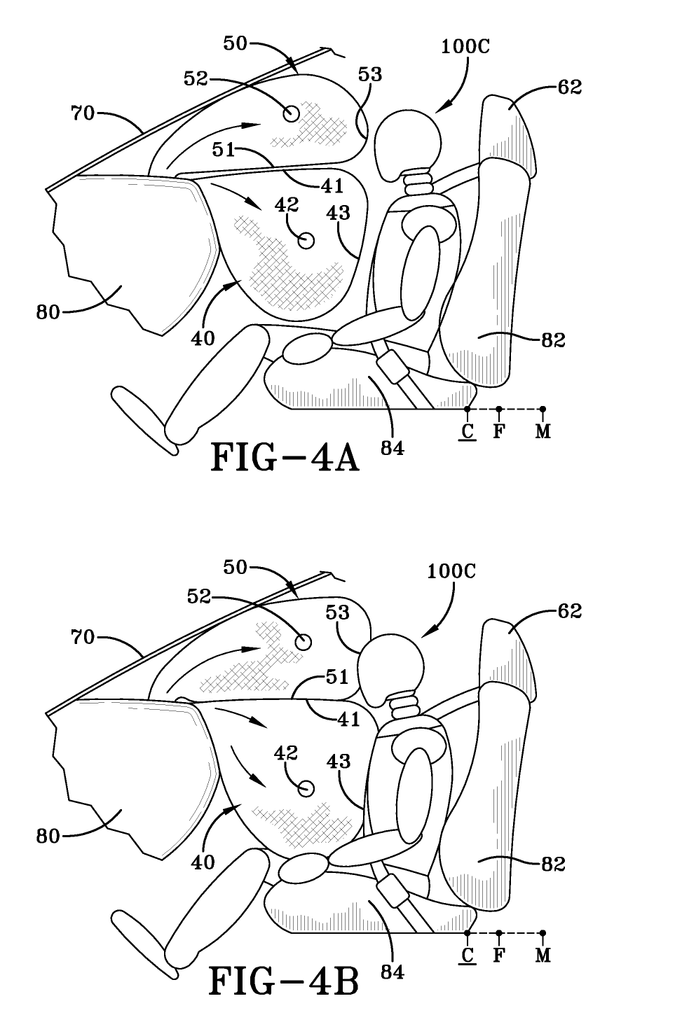

With reference to FIGS. 4A and 4B a child 100C of the three to six year age group is shown seated in the location C and the child is also shown restrained by a seatbelt system 62. As shown the lower airbag 40 strikes the child in the torso region driving him further back in the seat 82 and the upper airbag 50 strikes the child 100C in the head region. While these child vehicle occupants are substantially smaller than the 50^{th} percentile male or the 5^{th} percentile female, it is also true that these child vehicle occupants will normally be seated directly on the seat portion 84 as shown or could be in a booster child seat thereby moving the vehicle occupant vertically upwardly. This is true because most vehicle occupants want to see out of the windshield meaning the head is positioned above the instrument panel 80. Using this as a guideline it is possible to provide the vehicle occupant with an airbag system that provides a lower airbag 40 for striking the torso and an upper airbag 50 that will contact the head as shown.

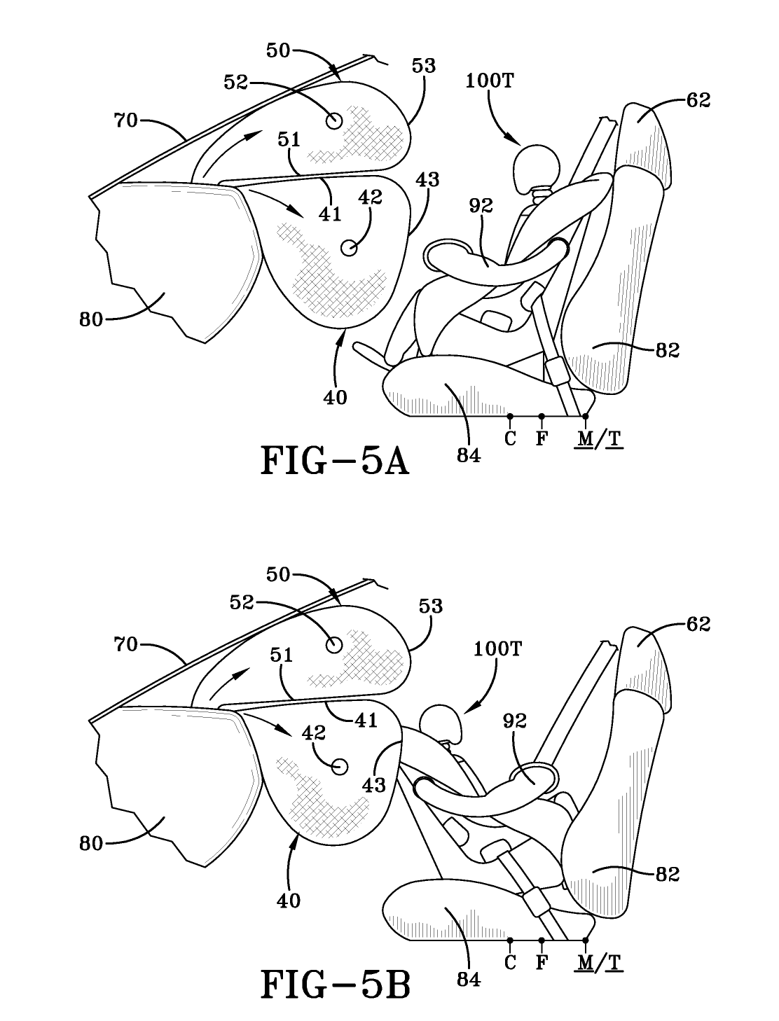

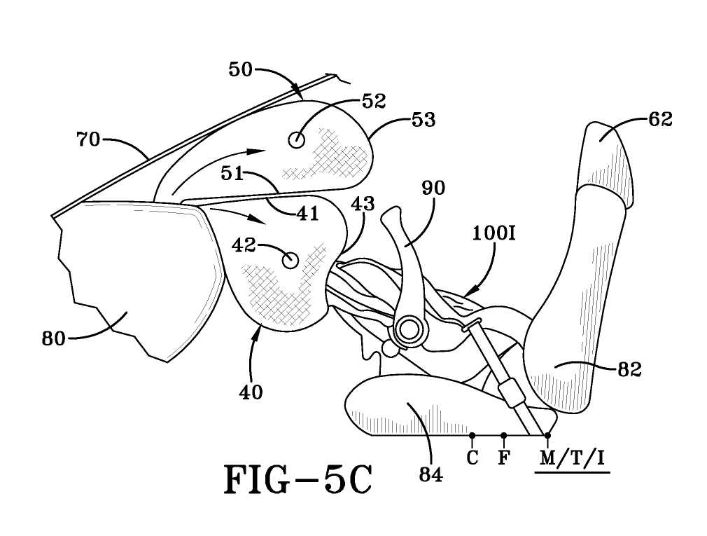

Another advantage of the present system is shown in FIGS. 5A, 5B and 5C wherein the airbag module assembly can be used in such a fashion that a rearward seated toddler 100T, a forward seated toddler 100T of a weight of twenty to forty pounds or a rearward seated infant 100I in a rearward facing infant seat 90 fastened to the seat 82 would be protected by the airbags 40, 50 to the extent that the rearward facing infant seat 90 would be impinged only by the lower airbag 40 while the upper airbag 50 would not have a tendency to provide an upward thrust on the infant seat. The airbags as shown would be suitable for a situation where an infant is placed in such a rearward facing infant seat 90 attached to a vehicle seat 82. Similarly a small toddler 100T typically weighing twenty to forty pounds could be placed in a rearward facing child seat 92 and a larger toddler of forty pounds or greater could be placed in a forward facing child restraint seat 92 wherein the lower airbag 40 and the upper airbag 50 operate to provide an air cushion protection safely due to the independent action of the airbags 40, 50 and their generally horizontal directed deployment on contact with the vehicle occupant. While front passenger seating of toddlers and infants is not generally recommended in today's motor vehicles, it is important to note that providing an airbag system 30 of the present invention makes it feasible for such a condition to occur as many drivers would prefer to have their infant child in the forward passenger compartment so they are easily accessible. In many small two seat motor vehicles such seating is inevitable. Unfortunately, heretofore, the present airbag systems do not provide a means for doing this in a safe manner. The present invention provides the capability of allowing this to occur in that the lower airbag 40 will prevent the upper airbag 50 from ever contacting the infant 100I in the rearward facing infant seat 90 and the impact on the toddlers' upper extremities is greatly reduced by the use of two independent airbags. Each of the airbags 40, 50 is provided with vent holes 42, 52 to ensure that upon inflation the airbags 40, 50 can deflate after deployment.

A passenger side airbag module assembly 30 for restraining movement of an adult or a child is accomplished by providing an airbag module housing 34 for attaching or holding an upper airbag 50 and a lower airbag 40. The lower airbag 40 is positioned in front of the upper airbag 50 in the module housing 34. Each airbag is inflated by an inflator 2.

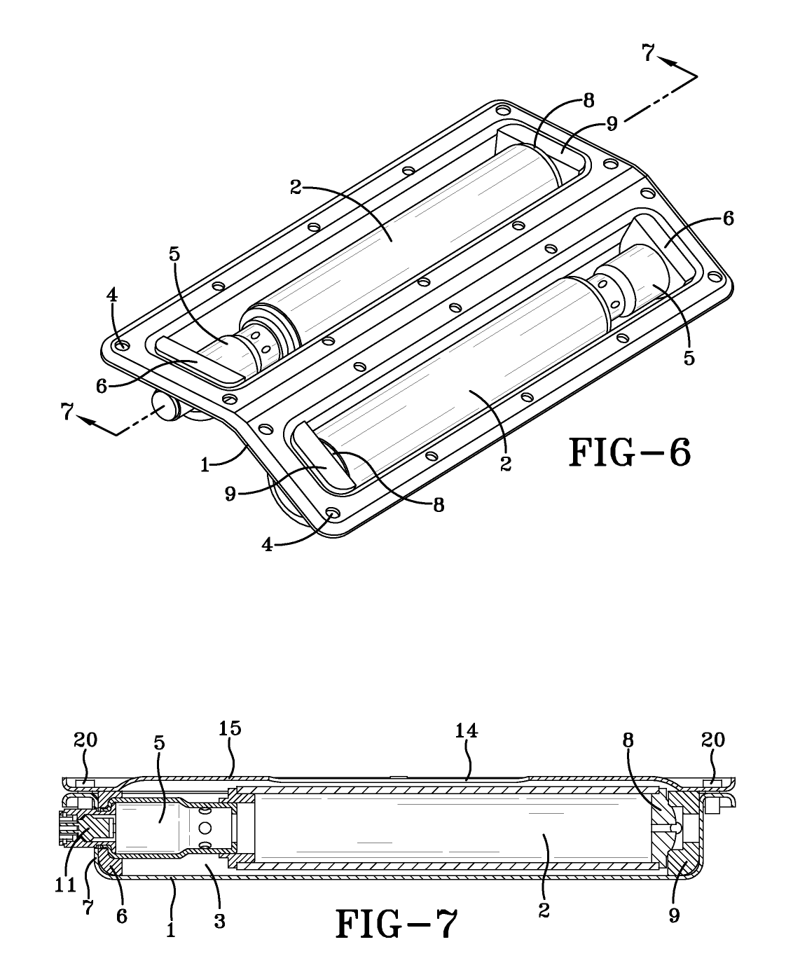

In the embodiment shown in FIGS. 6-9 two inflators are employed. The inflator 2 shown in FIG. 7 is single stage inflator having only a single inflator output level. A first inflator 2 is provided for inflating the upper airbag 50 and a second inflator 2 is provided for inflating the lower airbag 40. Each inflator 2 is housed within the airbag module housing 34. A means 15 for attaching to and to direct the deployment of each airbag from the airbag module is provided. The means 15 for attaching the airbag provides a means of separating the inflation gases from the first inflator 2 and the second inflator 2 such that each can act independently to inflate their respective airbags 40, 50. The airbag module assembly 30 further includes a means for activating 5 one or both inflators whereupon deployment the lower airbag 40 has an upper surface 41 that extends outwardly from the housing 34 and is substantially horizontal or lower than horizontal in direction and the upper airbag 50 extends with the lower surface 51 adjacent to the upper surface 41 of the lower airbag 40. The upper airbag 50 when deployed is adjacent to the windshield 70 of the motor vehicle and above the lower airbag 40.

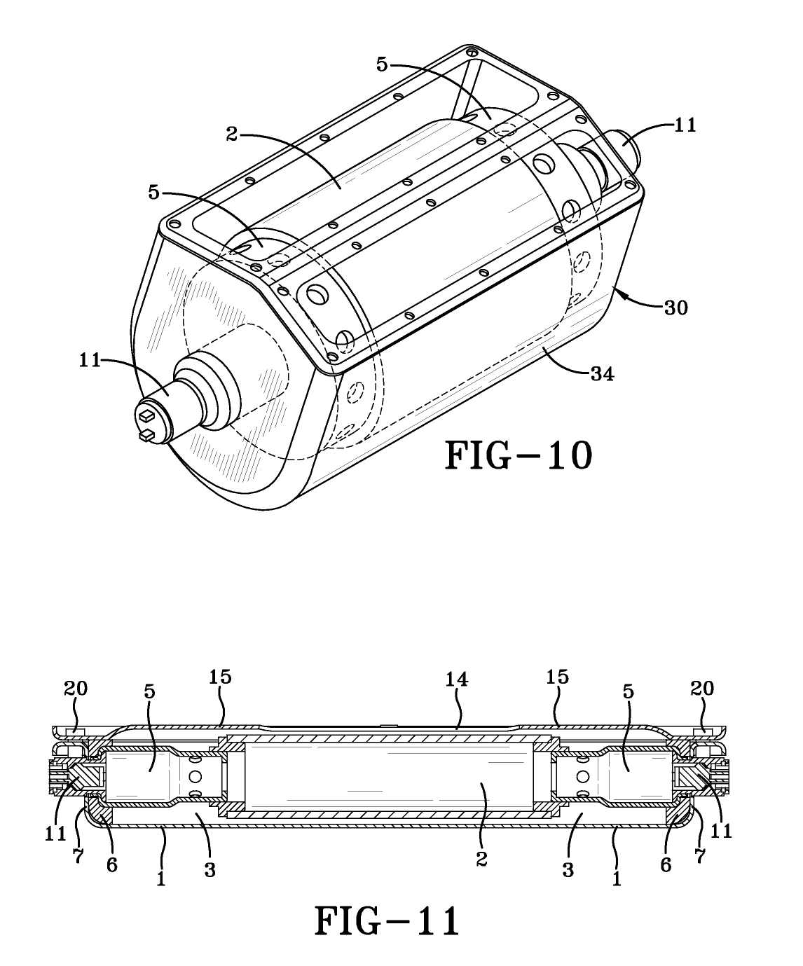

This method of deployment ensures that a vehicle occupant when looking out a windshield will be struck by the lower airbag 40 upon initial contact in the region of the torso while the upper airbag 50 would strike primarily the head region of the vehicle occupant. Preferably each of the inflators 2 has at least two or more inflator outputs, a low inflator output for low risk deployment requirements and a high or full inflator output for dynamic performance requirements wherein the means for activating 5 can selectively activate one or both airbags 40, 50 at the same or different output levels. With reference to FIG. 11, there is illustrated an inflator 2 that has two stages, or at least two inflator output levels. This is particularly beneficial in low impact risk wherein an aggressive deployment of the airbag would not be desirable. However, a lower output level would sufficiently protect the vehicle occupants with minimal risk. In a more severe crash a dynamic response would be needed and the inflators 2 could provide full gas inflation such that both of the airbags 40, 50 deploy rapidly and quickly to provide maximum protection. The lower cushion airbag 40 alone or in combination with the upper cushion airbag 50 when deployed at low inflator outputs will provide the low risk deployment requirement for three to six year old children. This is true in that these children generally are seated in a condition wherein they are seated in a position where they can view through the windshield and over the instrument panel. If this is the condition the lower airbag 40 will clearly strike the child 100C around the torso area and provide maximum protection for children in this location. The second inflator 2 activated at high or full output provides the low risk deployment requirement for a one year old in a rearward seated infant seat 90. This is important in that normally children are not seated in a front passenger side seat for fear that the airbag will provide a risk of injury to the infant seated in such a rear seated infant seat. The present invention permits the lower airbag 40 to provide contact initially to the rearward facing infant seat 90 and since it is moving in a primarily horizontal position independent of any upward thrust it is clear that the airbag 40 can fulfill this requirement. When both the first and second inflators 2 are activated at high or full output levels the airbag dynamic performance for a 5^{th} and 50^{th} percentile adult is clearly achieved. In many cases it is desirable to have the lower airbag 40 deployed preceding the upper airbag 50 by having a second inflator 2 activated prior to the first inflator 2, wherein the second inflator 2 will inflate the lower airbag 40 initially while the first inflator 2 being delayed slightly will then start to inflate the upper airbag 50.

It may be preferable to provide a means 5 for activating that is responsive to one or more sensor means for establishing the vehicle occupant's size or position and the severity of a crash and a means for controlling the output gas levels. This is commonly done in many of the airbag systems currently provided in motor vehicles. These sensors (not illustrated) can be used in combination with the airbag module assembly 30 of the present invention to provide a more sophisticated sensing for the vehicle occupants and the vehicle occupant's position enabling the airbags 40, 50 to act either independently or in cooperation with each other to complimentarily provide the best crash protection for a given vehicle occupant and crash scenario.

The upper airbag 50 and the lower airbag 40 each has a frontal surface 43, 53 that extends toward a vehicle occupant a distance substantially equal relative to the vehicle occupant when the airbags 40, 50 are fully deployed. The frontal surface 43 of the lower airbag 40 upon contact with a seated vehicle occupant will initially contact the vehicle occupant's torso well below the chin as previously mentioned when the vehicle occupant is properly positioned to look through the windshield. The frontal surface 53 of the upper airbag 50 upon contact with the seated vehicle occupant will initially contact the vehicle occupant's head above the chin when the vehicle occupant is properly positioned to look through the windshield. An out of position vehicle occupant upon initial inflation of the lower airbag 40 will be pushed rearward toward the seat 82 prior to the upper airbag 50 being deployed if the airbags 40, 50 are sequenced such that the lower airbag 40 is initially inflated prior to beginning the inflation of the upper airbag 50. This is beneficial when a vehicle occupant has a limb that is positioned on or in contact with the instrument panel. Preferably a means for sensing an out of position vehicle occupant having one or more legs resting on the instrument panel 80 can be detected such that the lower airbag 40 can be deployed at low or high inflation output without inflating the upper airbag 50, if so desired. An exemplary airbag module assembly is described in FIGS. 6 through 9.

FIG. 6 shows two inflators 2 mounted to a base plate 1. The base plate 1 serves the purposes of housing the inflators 2 and directing gas flow from the inflators. The base plate 1 has two cylindrically shaped recesses 3 defining an area for receiving tubular shaped inflators. One skilled in the art appreciates that other shaped recesses 3 can be utilized to accommodate other shaped inflators. The base plate 1 is made from stainless steel, but other suitable materials may be employed such as aluminum, plastics, etc. Around the circumference of the base plate 1 and along the dividing member, there are a plurality of holes 4 for receiving fasteners 20 for fastening the top plate 15 to the base plate 1.

The inflators 2 shown in FIG. 7 have an end cap 5 comprising a squib or igniter 11. The igniter 11 has a socket for receiving an electrical wire from an electronic control unit (not shown), which receives signals from various crash and/or vehicle occupant sensors that also are not shown. The inflators 2 in FIG. 6 represent generic inflators and may be cold gas inflators or hybrid inflators. Both of these inflators have a generally tubular shape. A cold gas inflator operates by quickly releasing inflation gas to fill an airbag. A hybrid inflator operates by releasing heated inflation gas to fill an airbag. The gas is heated by burning a heating material that is mixed with stored gas. Even though not illustrated, other types of inflators may be employed in the present invention namely a pyrotechnic inflator.

The inflators 2 are installed into the base plate 1 by first adding a first retainer 6 to the end cap 5 of the inflator. The first retainer 6 is preferably made from a nylon material. The base plate 1 has one large igniter access slot 7 on each of its side portions for receiving the end caps 5 of the inflators. Each inflator is secured to the base plate 1 by an interference fit created by the incorporation of a second retainer 9 between the bottom end 8 of the inflator and the base plate 1. The second retainer 9 is added after the inflator is dropped into the base plate 1 and slid as far as possible in the direction of the slot 7. The present invention may accommodate inflators 2 of various lengths by utilizing retainers of various thicknesses. Preferably, the inflators 2 are oriented in opposite directions so that the end cap of one inflator is facing the opposite direction as the end cap from the other inflator. The benefit of mounting the inflators in opposite directions is the avoidance of accidental actuation of an inflator by the other inflator. Even though highly improbable, the heat generated by the actuation of one inflator could ignite pyrotechnic material in the second inflator. Even though not the preferred embodiment, the inflators 2 may be positioned so that they are facing the same direction.

FIG. 7 shows a side cross sectional view of one of the inflators 2 mounted in the base plate 1. In FIG. 7 the retainer 9 abuts both the bottom end 8 of the inflator and the sidewall of the base plate 1. The retainer 9 prevents the inflator from sliding back and forth in the base plate 1.

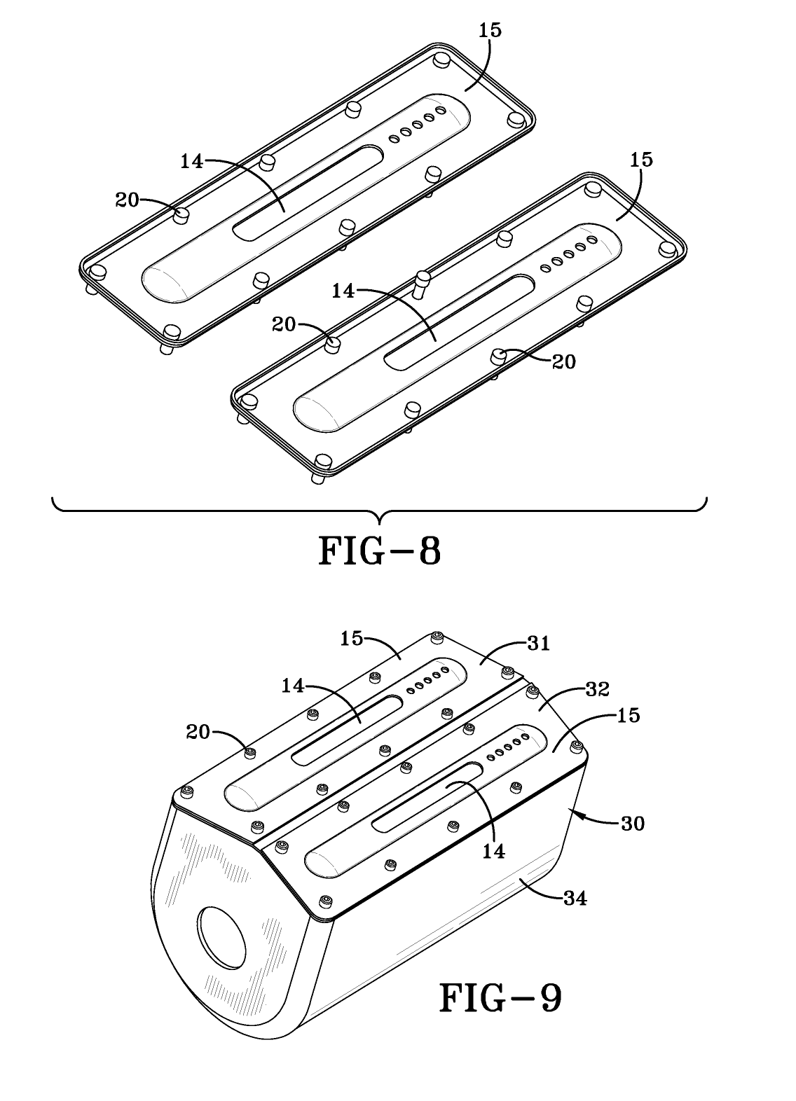

The top plates 15 are shown in FIG. 8, and each of these plates has a long cut out section 14 for inflation gas to pass through during the inflation of the airbag. Only inflation gas from one inflator travels through one top plate 15. As shown the top plates 15 when attached to the base plate 1 provide a means for directing the gas flow and the deployment of the airbag. As shown in FIG. 9 the module housing 30 holds both of the inflators 2 and provides a forward location 31 for attaching a lower airbag 40 and a rear location 32 for attaching an upper airbag 50.

The two airbags 40, 50 contemplated in the present invention are made of a suitable airbag material. Each airbag comprises an inflation chamber that is capable of receiving inflation gas upon deployment of the vehicle occupant protection system during a motor vehicle crash. The airbag material of each airbag 40, 50 has a ventilation opening 42, 52 therein for venting inflation gas to provide a compliant airbag surface upon impact by a vehicle occupant. As used herein, the term “airbag material” is understood to mean any suitable coated or uncoated woven or knit fabric as well as nonwoven films that may be used for an airbag.

The airbags 40, 50 are attached to the base plate 1 via the top plates 15. The top plates 15 are inserted into separate airbags. The holes (not shown) of the top plates 15 are aligned with the gas inlet openings of the airbags (not shown). Fasteners 20 are inserted through the holes in the top plates 15, the holes in the airbags, and then through the holes in the base plate 1. As opposes to the fasteners being inserted through the holes in the top plate 15, the fasteners may be permanently affixed to the top plate. Nuts are utilized to engage with the fasteners to secure them in place. Alternatively, the holes in the base plate 1 may be threaded eliminating the need for nuts.

In operation, inflation gas exits the inflator 2 through the exit ports. The base plate 1 acts as a manifold in directing the inflation gas toward the airbags 40, 50. The inflation gas passes through the cut out section 14 in the top plate 15 and ultimately travels into the airbag 40, 50. Inflation gas from one of the inflators 2 provides inflation gas for the lower airbag 40, and the other inflator provides inflation gas for the upper airbag 50. The utilization of two separate top plates 15 ensures that inflation gas from one of the inflators 2 only flows into one of the airbags. As shown to facilitate the substantially horizontal deployment of the lower airbag 40 the base plate 15 is inclined slightly such that the opening 14 is tilted at least slightly in the forward direction whereas the base plate 15 of the upper airbag is horizontally oriented to direct the upper airbag along the windshield and outward toward the vehicle occupant.

With reference to FIGS. 10 and 11, a preferred embodiment is shown wherein the two inflators 2 are replaced by a single inflator 2. In this embodiment the single inflator 2 is of a type having a dual inflator output levels. The dual output level inflator 2 accordingly has a first output level for simultaneously filling both the lower airbag 40 and the upper airbag 50 at a high inflation pressure and a second output level for filling the airbags 40, 50 at a lower inflation pressure. The inflator 2 shown in FIG. 11 is similar to the inflator 2 shown in FIG. 7, but it has two end caps 5 and two a squibs or igniters 11. The inflator 2 in FIG. 11 represents generic multi-stage inflators and may be a cold gas inflator or hybrid inflator, or even an all pyrotechnic inflator. As shown the inflator2 in FIG. 11 has a generally tubular shape. In a high risk deployment both igniters 11 fire allowing for a rapid inflation at a high pressure. In the lower risk deployment one igniter is fired allowing the air bags 40, 50 to fill simultaneously, but at a lower pressure. The airbag housing is designed to allow the inflation gases to pass through both openings or long cut out sections 14 in the top plate 15 as was described earlier in the two inflator design, this preferred embodiment is simple and lower in cost while still providing the benefits earlier described. The only significant difference is the single inflator cannot sequentially fill the airbags 40, 50 but fills both simultaneously.

While the invention has been described by reference to certain preferred embodiments, it should be understood that numerous changes could be made within the spirit and scope of the inventive concepts described. Accordingly it is intended that the invention not be limited to the disclosed embodiments, but that it have the full scope permitted by the language of the following claims.

What is claimed is:

1. An airbag module assembly comprising:
an airbag module housing;
an upper airbag;
a lower airbag positioned in front of the upper airbag in the module housing;
an inflator for filling both the upper airbag and the lower airbag;
a means for attaching and to direct the deployment of each airbag from the airbag module;
a means for activating one or both of the inflators; wherein
upon deployment the lower airbag has an upper surface that extends outwardly from the housing in a substantially horizontal or lower than horizontal direction and the upper airbag extends with a lower surface adjacent to the upper surface of the lower airbag; the upper airbag being deployed adjacent to the windshield of the vehicle and above the lower airbag.

2. The airbag module assembly of claim 1 wherein the inflator has at least two or more inflator outputs, a low inflator output for low risk deployment (LRD) requirements and a high or full inflator output for dynamic performance requirements and wherein the means for activating activates both airbags simultaneously at the same output levels.

3. The airbag module assembly of claim 2 wherein the lower cushion alone or in combination with the upper cushion when deployed at a low inflator output provides the LRD requirement for 3 year and 6 year old children.

4. The airbag module assembly of claim 2 wherein both the first and second inflators are activated at high or full output levels meets the dynamic performance for a 5^{th} and a 50^{th} percentile adult.

5. The airbag module assembly of claim 2 wherein the means for activating employs one or more sensor means for establishing the occupant size or position and severity of a crash and a means controlling the inflator gas output levels.

6. The airbag module assembly of claim 1 wherein the upper airbag and the lower airbag each has a frontal surface, the upper frontal surface extending outwardly towards an occupant a distance substantially equal to the lower airbag frontal surface relative to an occupant when fully deployed.

7. The airbag module assembly of claim 6 wherein the frontal surface of the lower airbag upon contact with a seated occupant will initially contact the occupant's torso below the chin when the occupant is properly positioned to view out the front windshield.

8. The airbag module assembly of claim 6 wherein the frontal surface of the upper airbag upon contact with a seated occupant will initially contact the occupant's head above the chin when the occupant is properly positioned to view out the front windshield.

9. An airbag module assembly comprising:
an airbag module housing;
an upper airbag;
a lower airbag positioned in front of the upper airbag in the module housing;
a first inflator for inflating the upper airbag, the first inflator being in a rearward position of the module housing;
a second inflator for inflating the lower airbag, the second inflator being in front of the first inflator in the module housing
a means for attaching and to direct the activation of each inflator, thereby directing the deployment of each airbag from the airbag module;
a means for activating the inflators; wherein
upon deployment the lower airbag has an upper surface that extends outwardly from the airbag module housing in a substantially horizontal or lower than horizontal direction and the upper airbag extends with a lower surface adjacent to the upper surface of the lower airbag; the upper airbag being deployed between the lower airbag and a windshield of a motor vehicle.

10. The airbag module assembly of claim 9 wherein both the first and second inflators have at least two inflator output levels, a low inflator output for low risk deployment requirements and a high or full inflator output for dynamic performance requirements and wherein the means for activating the inflators can selectively activate one or both inflators, can activate the inflators simultaneously or at different times, and the inflators can be activated at the same or different output levels.

11. The airbag module assembly of claim 10 wherein the lower airbag alone or in combination with the upper airbag when deployed at a low inflator output provides the low risk deployment requirement for three to six year old children.

12. The airbag module assembly of claim 10 wherein the second inflator is activated at a high or full inflator output to meet the low risk deployment requirement for a one year old in a rear seated infant restraint seat.

13. The airbag module assembly of claim 10 wherein both the first and second inflators are activated at high or full output levels to meet the dynamic performance requirement for a 5^{th} and a 50^{th} percentile adult.

14. The airbag module assembly of claim 11 wherein the lower airbag is deployed preceding the upper airbag by having the second inflator activated prior to the first inflator.

15. The airbag module assembly of claim 10 wherein the means for activating comprises one or more sensor means for establishing the vehicle occupant size or position and severity of a crash and a means controlling the inflator gas output levels.

16. The airbag module assembly of claim 9 wherein the upper airbag and the lower airbag each has a frontal surface, an upper frontal surface extending towards a vehicle occupant a distance substantially equal to the frontal surface of the lower airbag relative to a vehicle occupant when fully deployed.

17. The airbag module assembly of claim 16 wherein the frontal surface of the lower airbag upon contact with a seated vehicle occupant will initially contact the vehicle occupant's torso below the chin of the vehicle occupant when the seated vehicle occupant is not out of position.

18. The airbag module assembly of claim 16 wherein the frontal surface of the upper airbag upon contact with a seated vehicle occupant will initially contact the vehicle occupant's head above the vehicle occupant's chin when the seated vehicle occupant is not out of position.

19. The airbag module assembly of claim 13 wherein an out of position vehicle occupant upon initial inflation of the lower airbag will be pushed toward the seat back prior to the upper airbag being deployed.

20. The airbag module assembly of claim 9 wherein a means for sensing an out of position vehicle occupant having one or more legs resting on an instrument panel can be detected such that the lower airbag can be deployed at low or high inflator output without inflating the upper airbag.

21. An airbag module assembly comprising:
an airbag module housing;
a lower airbag that in a deployed state has an upper surface that extends from the airbag module housing in a substantially horizontal or lower than horizontal direction, the lower airbag having a frontal surface that upon contact with a seated vehicle occupant will initially contact the vehicle occupant's torso below the chin of the vehicle occupant when the seated vehicle occupant is not out of position;
an upper airbag that in a deployed state is located above the lower airbag and has a frontal surface that upon contact with the seated vehicle occupant will initially contact the vehicle occupant's head above the vehicle occupant's chin when the seated vehicle occupant is not out of position;
a first inflator in the module housing for inflating the upper airbag, and a second inflator in the module housing for inflating the lower airbag; and
a means for ensuring that inflation gas from the first inflator flows into only the upper airbag and inflation gas from the second inflator flows into only the lower airbag.

22. The airbag module assembly of claim 21 further comprising a means for activating the first and second inflators, and wherein both the first and second inflators each have at least two inflator output levels and the means for activating the inflators can selectively activate one or both inflators, can activate the inflators simultaneously or at different times, and the inflators can be activated at the same or different output levels.

23. The airbag module assembly of claim 22 wherein the means for activating the inflators comprises one or more sensor means and a means controlling the inflator output level based upon the vehicle occupant's size or position and the severity of a crash as determined by the sensor means.

24. The airbag module assembly of claim 23 wherein an out of position vehicle occupant upon initial inflation of the lower airbag will be pushed toward the seat back prior to the upper airbag being deployed.

25. An airbag module assembly comprising:
an airbag module housing;
a lower airbag that in a deployed state has an upper surface that extends from the airbag module housing in a substantially horizontal or lower than horizontal direction, the lower airbag having a frontal surface that contacts rearward facing infant seat fastened to a seat of a motor vehicle;
an upper airbag that in a deployed state is located above the lower airbag and has a frontal surface that does not contact the rearward facing infant seat fastened to the seat of the motor vehicle;
a first inflator in the module housing for inflating the upper airbag, and a second inflator in the module housing for inflating the lower airbag; and
a means for ensuring that inflation gas from the first inflator flows into only the upper airbag and inflation gas from the second inflator flows into only the lower airbag.

26. The airbag module assembly of claim 25 further comprising a means for activating the first and second inflators, and wherein both the first and second inflators each have at least two inflator output levels and the means for activating the inflators can selectively activate one or both inflators, can activate the inflators simultaneously or at different times, and the inflators can be activated at the same or different output levels.

27. The airbag module assembly of claim 26 wherein the means for activating the inflators comprises one or more sensor means and a means for controlling the inflator activation and output level based upon the presence of an infant seat as determined by the sensor means.

28. An airbag module assembly comprising:
an airbag module housing;
a lower airbag that in a deployed state has an upper surface that extends from the airbag module housing in a substantially horizontal or lower than horizontal direction, the lower airbag having a frontal surface that upon contact with a seated vehicle occupant will initially contact the vehicle occupant's torso below the chin of the vehicle occupant when the seated vehicle occupant is not out of position;
an upper airbag that in a deployed state is located above the lower airbag and has a frontal surface that upon contact with the seated vehicle occupant will initially contact the vehicle occupant's head above the vehicle occupant's chin when the seated vehicle occupant is not out of position;
an inflator for filling both the upper airbag and the lower airbag, the inflator having at least two inflator output levels, and a means for activating the inflator that activates the inflator to deploy airbags simultaneously using a single inflator output level.

29. The airbag module assembly of claim 28 wherein the means for activating the inflator comprises one or more sensor means and a means for controlling the inflator output level based upon the vehicle occupant's size or position and the severity of a crash as determined by the sensor means.

30. An airbag module assembly comprising:
an airbag module housing;
a lower airbag that in a deployed state has an upper surface that extends from the airbag module housing in a substantially horizontal or lower than horizontal direction, the lower airbag having a frontal surface that contacts rearward facing infant seat fastened to a seat of a motor vehicle;
an upper airbag that in a deployed state is located above the lower airbag and has a frontal surface that does not contact the rearward facing infant seat fastened to the seat of the motor vehicle;
an inflator for filling both the upper airbag and the lower airbag, the inflator having at least two inflator output levels, and a means for activating the inflator that activates the inflator to deploy airbags simultaneously using a single inflator output level.

31. The airbag module assembly of claim 30 wherein the means for activating the inflator comprises one or more sensor means and a means for controlling the inflator output level based upon the vehicle occupant's size or position and the severity of a crash as determined by the sensor means.
